(19) United States
(12) Patent Application Publication
(10) Pub. No.: US 2025/0272690 A1
(43) Pub. Date: Aug. 28, 2025

(54) METHOD OF DETERMINING FRAUD IN AN INSURANCE ANALYSIS

(71) Applicant: CCC INTELLIGENT SOLUTIONS, INC., Chicago, IL (US)

(72) Inventor: Marc FREDMAN, Chicago, IL (US)

(21) Appl. No.: 18/590,145

(22) Filed: Feb. 28, 2024

(51) Int. Cl. G06Q 20/40; G06Q 40/08

(52) U.S. Cl. CPC G06Q 20/4016; G06Q 40/08

(57) ABSTRACT

The method may determine whether a user desires a cash payout. In response to determining the user desires a cash payout, the method may determine a trust score for the user. The trust score may be determined by reviewing the facts of the situation or machine learning may be used to identify factors in past fraudulent claims and applying the factor analysis to new claims. The trust score may be analyzed to determine if the trust score is over a threshold. In response to the trust score being over the threshold, the method may recommending paying the claim. In response to the trust score being under the threshold, the method may proceed to follow a configurable rules engine on how to further investigate the claim.

### BACKGROUND

Insurance fraud has long been an issue. Even movies have been made where insurance fraud schemes are depicted to enrich the characters. Logically, insurance companies attempt to reduce insurance fraud which results in a type of “cat and mouse” game where fraudsters attempt new ways to fraudulently obtain insurance proceeds and insurance companies try new ways to stop the fraud.

Further, the use of photographs to document damage for insurance claims has created the potential for AI-assisted fraudsters to submit fake or doctored photos of damage. Insurance companies attempt to detect fake photographs but a better and all-encompassing system to identify possible fraudsters and having a plan with how to respond to the fraud threat is needed.

### SUMMARY

A method of determining fraud in an insurance analysis is disclosed. The method may determine whether a user desires a cash payout as fraudsters rarely want damage fixed. In response to determining the user desires a cash payout, the method may determine a trust score for the user. The trust score may be determined by reviewing the facts of the situation or machine learning may be used to identify factors in past fraudulent claims and applying the factor analysis to new claims. The trust score may be analyzed to determine if the trust score is over a threshold. In response to the trust score being over the threshold, the method may proceed to pay out the claim and in response to the trust score being under the threshold, the method may proceed to use a configurable rules engine to create a plan to further investigate the claim.

### BRIEF DESCRIPTION OF THE DRAWINGS

FIG. 1 may be an illustration of computer based learning system;

FIG. 2 may be an illustration of a method in accordance with the claims;

FIG. 3 may be an illustration of a convolutional neural network; and

FIG. 4 may be an illustration of a computer that may be physically transformed to execute the method.

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meanings have otherwise been set forth herein. All dimensions specified in this disclosure may be by way of example only and are not intended to be limiting. Further, the proportions shown in these Figures may not be necessarily to scale. As will be understood, the actual dimensions and proportions of any system, any device or part of a system or device disclosed in this disclosure may be determined by its intended use.

### SPECIFICATION

Insurance fraud has long been an issue. Even movies have been made where insurance fraud schemes are depicted to enrich the characters. Logically, insurance companies attempt to reduce insurance fraud which results in a type of cat and mouse game where fraudsters attempt new ways to fraudulently obtain insurance proceeds and insurance companies try new ways to stop the fraud.

Further, the use of photographs to document damage for insurance claims has created the potential for AI-assisted fraudsters to submit fake or doctored photos of damage. Insurance companies attempt to detect fake photographs but a better system to identify possible fraudsters and how to respond to them is needed.

A method of determining fraud in an insurance analysis is disclosed. The method may determine whether a user desires a cash payout as fraudsters rarely want damage fixed. In response to determining the user desires a cash payout, the method may determine a trust score for the user. The trust score may be determined by reviewing the facts of the situation or machine learning may be used to identify factors in past fraudulent claims and applying the factor analysis to new claims. The trust score may be analyzed to determine if the trust score is over a threshold. In response to the trust score being over the threshold, the method may proceed to pay out the claim and in response to the trust score being under the threshold, the method may proceed to further investigate the claim.

Methods and devices that may implement the embodiments of the various features of the invention will now be described with reference to the drawings. The drawings and the associated descriptions may be provided to illustrate embodiments of the invention and not to limit the scope of the invention. Reference in the specification to “one embodiment” or “an embodiment” may be intended to indicate that a particular feature, structure, or characteristic described in connection with the embodiment may be included in at least an embodiment of the invention. The appearances of the phrase “in one embodiment” or “an embodiment” in various places in the specification may not necessarily be referring to the same embodiment.

Throughout the drawings, reference numbers may be re-used to indicate correspondence between referenced elements. As used in this disclosure, except where the context requires otherwise, the term “comprise” and variations of the term, such as “comprising”, “comprises” and “comprised” may not be intended to exclude other additives, components, integers or steps.

In the following description, specific details may be given to provide a thorough understanding of the embodiments. However, it may be understood by one of ordinary skill in the art that the embodiments may be practiced without these specific details. Well-known circuits, structures and techniques may not be shown in detail in order not to obscure the embodiments. For example, circuits may be shown in block diagrams in order not to obscure the embodiments in unnecessary detail.

Also, it is noted that the embodiments may be described as a process that is depicted as a flowchart, a flow diagram, a structure diagram, or a block diagram. The flowcharts and block diagrams in the figures may illustrate the architecture, functionality, and operation of possible implementations of systems, methods and computer programs according to various embodiments disclosed. In this regard, each block in the flowchart or block diagrams may represent a module, segment, or portion of code, that may include one or more executable instructions for implementing the specified logical function(s). It should also be noted that, in some alternative implementations, the functions noted in the blocks may occur out of the order noted in the figures.

Although a flowchart may describe the operations as a sequential process, many of the operations may be performed in parallel or concurrently. In addition, the order of the operations may be rearranged. A process may be terminated when its operations are completed. A process may correspond to a method, a function, a procedure, a subroutine, a subprogram, etc. When a process corresponds to a function, its termination may correspond to a return of the function to the calling function or the main function. Additionally, each block of the block diagrams and/or flowchart illustration, and combinations of blocks in the block diagrams and/or flowchart illustration, may be implemented by special purpose hardware-based systems that perform the specified functions or acts, or combinations of special purpose hardware and computer instructions.

Moreover, a storage may represent one or more devices for storing data, including read-only memory (ROM), random access memory (RAM), magnetic disk storage mediums, optical storage mediums, flash memory devices and/or other non-transitory machine readable mediums for storing information. The term “machine readable medium” may include, but is not limited to portable or fixed storage devices, optical storage devices, wireless channels and various other non-transitory mediums capable of storing, comprising, containing, executing or carrying instruction(s) and/or data.

Furthermore, embodiments may be implemented by hardware, software, firmware, middleware, microcode, or a combination thereof. When implemented in software, firmware, middleware or microcode, the program code or code segments to perform the necessary tasks may be stored in a machine-readable medium such as a storage medium or other storage(s). One or more than one processor may perform the necessary tasks in series, distributed, concurrently or in parallel. A code segment may represent a procedure, a function, a subprogram, a program, a routine, a subroutine, a module, a software package, a class, or a combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted through a suitable means including memory sharing, message passing, token passing, network transmission, etc. and are also referred to as an interface, where the interface is the point of interaction with software, or computer hardware, or with peripheral devices.

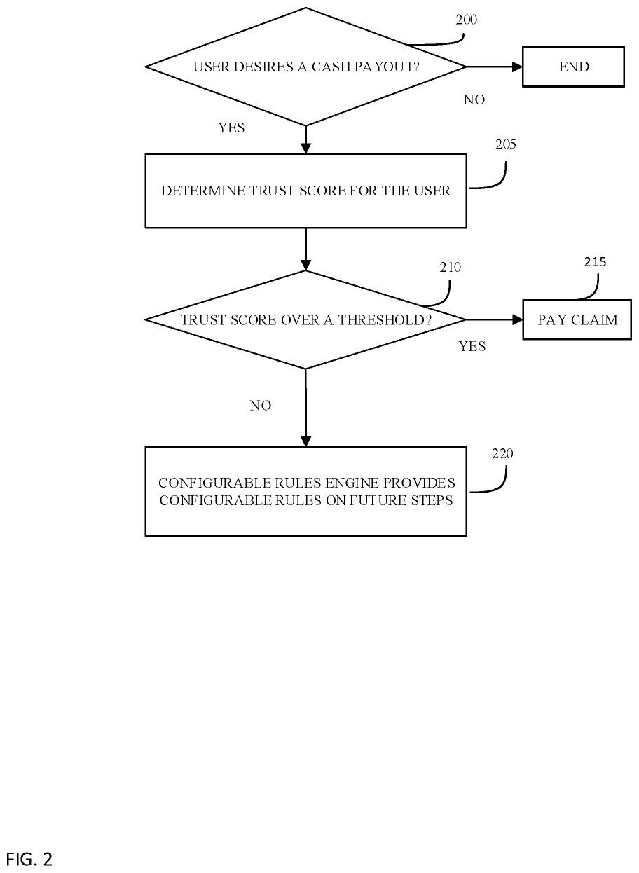

Referring to FIG. 2, at block 200, the method may determine whether a user desires a cash payout. History has shown that fraudsters desire cash. If the insured does not desire a cash payout, the method may end.

At block 205, in response to determining that the user desires a cash payout, a trust score for the user may be determined. The trust score may be determined in a variety of ways, some of which may be specific to the insurance industry and some which may be specific to the type of insurance in question. For example, the insurance may include but not be limited to home insurance, personal property insurance, vehicle insurance, casualty insurance, liability insurance, health insurance, pet insurance, disability insurance, business interruption insurance, professional liability insurance, flood insurance, commercial insurance, umbrella insurance and travel insurance. The method may be adjusted based on the type of damage in question.

The data on the insurance claim may be normalized. The insurance claim may have notes and some form fields filled in. A normalization engine may be used to take the notes and other information in the insurance claim and put it into a standard format such that the data may be easily and accurately analyzed.

More specifically, the system and method may use machine learning to analyze all the data in a claim file and determine the proper classification of the data. For example, notes about the weather during the claim incident may be added to a weather field while notes about any witnesses may be added to a witness field. However, the location of the weather data may be in a variety of places in the file. In some instances, the weather may be noted in a weather report. Not all weather reports are the same and the specific weather items of interest may be noted in different places on different forms. In other instances, the weather may be obtained from the claimant. In other instances, photographs of the scene may be analyzed to obtain weather information. In additional instances, additional outside resources such as online weather data may be consulted to obtain weather information. By normalizing the data, the data may be analyzed in a more consistent fashion.

Similar approaches may be used depending on the type of insurance that is involved. If the insurance is worker's compensation, the data on the accident may come from a variety of sources such as from a doctor, a supervisor, images from the worksite, etc. The injury data may be selected and placed in an injury field to aid in a consistent analysis of the injury. Of course, different data may be involved in each insurance type and the system and method may have the flexibility to handle each insurance type in a consistent fashion.

There may be a variety of factors that go into creating a trust score. It also may be noted these factors may vary depending on the type of insurance and the insurance company. For example, some insurance companies may attempt to fix every vehicle and may rarely make cash offers which may have different factors than an insurance company that is aggressive in totaling cars and offering cash payout. Similarly, damage to a house may be subject to different factors than damage to a vehicle.

A sample factor that may be analyzed is whether the user has recently made a change to their insurance. A common tactic of fraudsters is to buy a policy, make a small payment on the policy and then submit a claim for damages that vastly exceed the amount paid on the policy. In response to the method determining that the user has recently made a change to their insurance, the trust score may be decreased.

Another sample factor may be used in determining a trust score may be whether the insurance claimant is on a list of known fraudulent users. For example, police and other central databases may keep a list of people convicted of committing fraud in the past. In response to determining that the user is on the list of known fraudulent users, the trust score may be decreased.

Yet another sample factor may be used in determining a trust score may include determining if the user has a relevant history of no claims. For example, many fraudsters have a history of committing fraud against many different insurance companies and fraudsters seldom have a long history of no claims with the same insurance company. Thus, in response to determining that the user has a relevant history of no claims, the trust score may be increased.

As yet another sample factor that may be used in determining a trust score, the method may determine if the user has any past claims where a cash payout request was requested. The concept is that a fraudster may repeatedly seek cash from insurance companies and that a fraudster that has taken cash in the past will try to do so again in the future. In response to determining that the user does not have any past claims where a cash payout request was requested, the trust score may be increased.

In another sample factor that may be used in determining a trust score, a location of an incident may be determined and compared to the location of fraud incident locations in the past. The concept may be that a fraudster may be able to continually find locations where accidents may be easily created and that location may be used repeatedly. If the location is similar to a location of a fraud incident in the past, the trust score down may be adjusted down.

In another example, data may be gathered from additional sources related to trust and the method may adjust the trust score based on the data from additional sources. For example, a credit report may indicate that fraud issues that have occurred in the past. Similarly, police reports or court cases involving fraud may indicate that a trust score should be adjusted lower.

In yet another example, the method may determine if an additional party to the incident has a negative trust rating. The concept is that a fraudster will be likely to commit a fraud with a person that also has a history in fraud. In response to determining the additional party has a negative trust rating, the method may adjust the trust score down.

In some alternative embodiments, past instances of insurance fraud may be analyzed by a machine learning algorithm to determine features that are related to insurance fraud.

### Machine Learning

Machine learning may be used to recognize patterns. The machine learning model may be trained on a model on an existing dataset and the model may be used to predict whether the facts of a claim match known patterns. The machine learning model may be used to predict future actions based on past pattern recognition. The machine learning model may also be used to determine pattern deviation. Logically, pattern deviation may be used to determine future actions.

A framework for machine learning algorithm like a large language model may involve a combination of one or more components, sometimes three components: (1) representation, (2) evaluation, and (3) optimization components. Representation components refer to computing units that perform steps to represent knowledge in different ways, including but not limited to as one or more decision trees, sets of rules, instances, graphical models, neural networks, support vector machines, model ensembles, and/or others. Evaluation components refer to computing units that perform steps to represent the way hypotheses (e.g., candidate programs) are evaluated, including but not limited to as accuracy, prediction and recall, squared error, likelihood, posterior probability, cost, margin, entropy k-L divergence, and/or others. Optimization components refer to computing units that perform steps that generate candidate programs in different ways, including but not limited to combinatorial optimization, convex optimization, constrained optimization, and/or others. In some embodiments, other components and/or sub-components of the aforementioned components may be present in the system to further enhance and supplement the aforementioned machine learning functionality.

Machine learning algorithms sometimes rely on unique computing system structures. Machine learning algorithms may leverage neural networks, which are systems that approximate biological neural networks (e.g., the human brain). Such structures, while significantly more complex than conventional computer systems, are beneficial in implementing machine learning. For example, an artificial neural network may be comprised of a large set of nodes which, like neurons in the brain, may be dynamically configured to effectuate learning and decision-making.

Machine learning tasks are sometimes broadly categorized as either unsupervised learning or supervised learning. In unsupervised learning, a machine learning algorithm is left to generate any output (e.g., to label as desired) without feedback. The machine learning algorithm may teach itself (e.g., observe past output), but otherwise operates without (or mostly without) feedback from, for example, a human administrator. Meanwhile, in supervised learning, a machine learning algorithm is provided feedback on its output. Feedback may be provided in a variety of ways, including via active learning, semi-supervised learning, and/or reinforcement learning. In active learning, a machine learning algorithm is allowed to query answers from an administrator. For example, the machine learning algorithm may make a guess in a face detection algorithm, ask an administrator to identify the photo in the picture, and compare the guess and the administrator's response. In semi-supervised learning, a machine learning algorithm is provided a set of example labels along with unlabeled data. For example, the machine learning algorithm may be provided a data set of 100 photos with labeled human faces and 10,000 random, unlabeled photos. In reinforcement learning, a machine learning algorithm is rewarded for correct labels, allowing it to iteratively observe conditions until rewards are consistently earned. For example, for every face correctly identified, the machine learning algorithm may be given a point and/or a score (e.g., “75% correct”). An embodiment involving supervised machine learning is described herein.

As elaborated herein, in practice, machine learning systems and their underlying components are tuned by data scientists to perform numerous steps to perfect machine learning systems. The process is sometimes iterative and may entail looping through a series of steps: (1) understanding the domain, prior knowledge, and goals; (2) data integration, selection, cleaning, and pre-processing; (3) learning models; (4) interpreting results; and/or (5) consolidating and deploying discovered knowledge. This may further include conferring with domain experts to refine the goals and make the goals more clear, given the nearly infinite number of variables that can possible be optimized in the machine learning system. Meanwhile, one or more of data integration, selection, cleaning, and/or pre-processing steps can sometimes be the most time consuming because the old adage, “garbage in, garbage out,” also reigns true in machine learning systems.

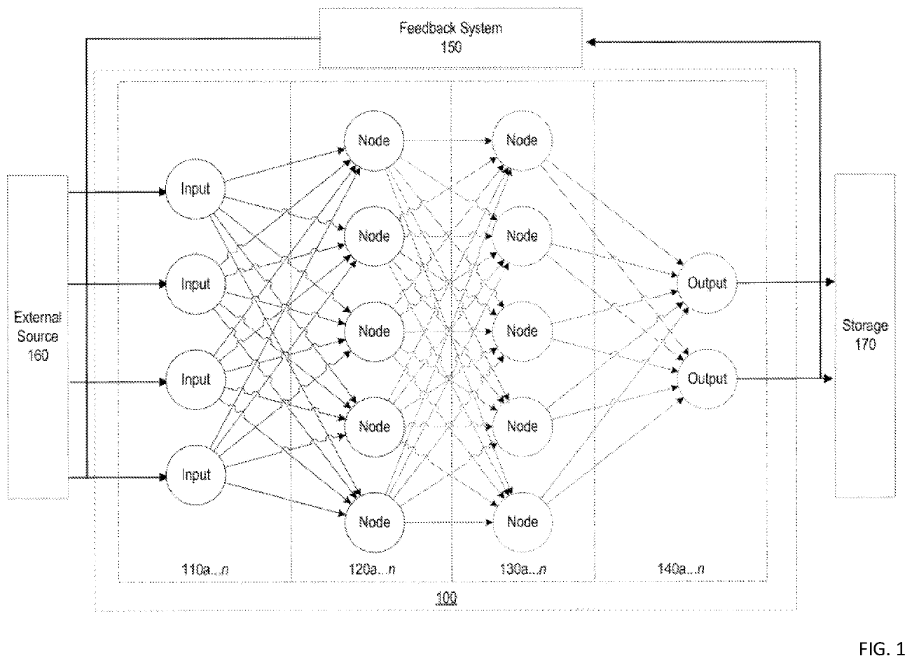

By way of example, FIG. 1 illustrates a simplified example of an artificial neural network 100 on which a machine learning algorithm may be executed. FIG. 1 is merely an example of nonlinear processing using an artificial neural network; other forms of nonlinear processing may be used to implement a machine learning algorithm in accordance with features described herein.

In FIG. 1, each of input nodes 110 a-n is connected to a first set of processing nodes 120 a-n. Each of the first set of processing nodes 120 a-n is connected to each of a second set of processing nodes 130 a-n. Each of the second set of processing nodes 130 a-n is connected to each of output nodes 140 a-n. Though only two sets of processing nodes are shown, any number of processing nodes may be implemented. Similarly, though only four input nodes, five processing nodes, and two output nodes per set are shown in FIG. 1, any number of nodes may be implemented per set. Data flows in FIG. 1 are depicted from left to right: data may be input into an input node, may flow through one or more processing nodes, and may be output by an output node. Input into the input nodes 110 a-n may originate from an external source 160. Output may be sent to a feedback system 150 and/or to storage 170. The feedback system 150 may send output to the input nodes 110 a-n for successive processing iterations with the same or different input data.

In one illustrative method using feedback system 150, the system may use machine learning to determine an output. The output may include anomaly scores, heat scores/values, confidence values, and/or classification output. The system may use any machine learning model including xgboosted decision trees, auto-encoders, perceptron, decision trees, support vector machines, regression, and/or a neural network. The neural network may be any type of neural network including a feed forward network, radial basis network, recurrent neural network, long/short term memory, gated recurrent unit, auto encoder, variational autoencoder, convolutional network, residual network, Kohonen network, and/or other type. In one example, the output data in the machine learning system may be represented as multi-dimensional arrays, an extension of two-dimensional tables (such as matrices) to data with higher dimensionality.

The neural network may include an input layer, a number of intermediate layers, and an output layer. Each layer may have its own weights. The input layer may be configured to receive as input one or more feature vectors described herein. The intermediate layers may be convolutional layers, pooling layers, dense (fully connected) layers, and/or other types. The input layer may pass inputs to the intermediate layers. In one example, each intermediate layer may process the output from the previous layer and then pass output to the next intermediate layer. The output layer may be configured to output a classification or a real value. In one example, the layers in the neural network may use an activation function such as a sigmoid function, a Tan h function, a ReLu function, and/or other functions. Moreover, the neural network may include a loss function. A loss function may, in some examples, measure a number of missed positives; alternatively, it may also measure a number of false positives. The loss function may be used to determine error when comparing an output value and a target value. For example, when training the neural network the output of the output layer may be used as a prediction and may be compared with a target value of a training instance to determine an error. The error may be used to update weights in each layer of the neural network.

In one example, the neural network may include a technique for updating the weights in one or more of the layers based on the error. The neural network may use gradient descent to update weights. Alternatively, the neural network may use an optimizer to update weights in each layer. For example, the optimizer may use various techniques, or combination of techniques, to update weights in each layer. When appropriate, the neural network may include a mechanism to prevent overfitting-regularization (such as L1 or L2), dropout, and/or other techniques. The neural network may also increase the amount of training data used to prevent overfitting.

Once data for machine learning has been created, an optimization process may be used to transform the machine learning model. The optimization process may include (1) training the data to predict an outcome, (2) defining a loss function that serves as an accurate measure to evaluate the machine learning model's performance, (3) minimizing the loss function, such as through a gradient descent algorithm or other algorithms, and/or (4) optimizing a sampling method, such as using a stochastic gradient descent (SGD) method where instead of feeding an entire dataset to the machine learning algorithm for the computation of each step, a subset of data is sampled sequentially. In one example, optimization comprises minimizing the number of false positives to maximize a user's experience. Alternatively, an optimization function may minimize the number of missed positives to optimize minimization of losses from exploits.

In one example, FIG. 1 depicts nodes that may perform various types of processing, such as discrete computations, computer programs, and/or mathematical functions implemented by a computing device. For example, the input nodes 110 a-n may comprise logical inputs of different data sources, such as one or more data servers. The processing nodes 120 a-n may comprise parallel processes executing on multiple servers in a data center. And, the output nodes 140 a-n may be the logical outputs that ultimately are stored in results data stores, such as the same or different data servers as for the input nodes 110 a-n. Notably, the nodes need not be distinct. For example, two nodes in any two sets may perform the exact same processing. The same node may be repeated for the same or different sets.

Each of the nodes may be connected to one or more other nodes. The connections may connect the output of a node to the input of another node. A connection may be correlated with a weighting value. For example, one connection may be weighted as more important or significant than another, thereby influencing the degree of further processing as input traverses across the artificial neural network. Such connections may be modified such that the artificial neural network 100 may learn and/or be dynamically reconfigured. Though nodes are depicted as having connections only to successive nodes in FIG. 1, connections may be formed between any nodes. For example, one processing node may be configured to send output to a previous processing node.

Input received in the input nodes 110 a-n may be processed through processing nodes, such as the first set of processing nodes 120 a-n and the second set of processing nodes 130 a-n. The processing may result in output in output nodes 140 a-n. As depicted by the connections from the first set of processing nodes 120 a-n and the second set of processing nodes 130 a-n, processing may comprise multiple steps or sequences. For example, the first set of processing nodes 120 a-n may be a rough data filter, whereas the second set of processing nodes 130 a-n may be a more detailed data filter.

The artificial neural network 100 may be configured to effectuate decision-making. As a simplified example for the purposes of explanation, the artificial neural network 100 may be configured to detect faces in photographs. The input nodes 110 a-n may be provided with a digital copy of a photograph. The first set of processing nodes 120 a-n may be each configured to perform specific steps to remove non-facial content, such as large contiguous sections of the color red. The second set of processing nodes 130 a-n may be each configured to look for rough approximations of faces, such as facial shapes and skin tones. Multiple subsequent sets may further refine this processing, each looking for further more specific tasks, with each node performing some form of processing which need not necessarily operate in the furtherance of that task. The artificial neural network 100 may then predict the location on the face. The prediction may be correct or incorrect.

The feedback system 150 may be configured to determine whether or not the artificial neural network 100 made a correct decision. Feedback may comprise an indication of a correct answer and/or an indication of an incorrect answer and/or a degree of correctness (e.g., a percentage). For example, in the facial recognition example provided above, the feedback system 150 may be configured to determine if the face was correctly identified and, if so, what percentage of the face was correctly identified. The feedback system 150 may already know a correct answer, such that the feedback system may train the artificial neural network 100 by indicating whether it made a correct decision. The feedback system 150 may comprise human input, such as an administrator telling the artificial neural network 100 whether it made a correct decision. The feedback system may provide feedback (e.g., an indication of whether the previous output was correct or incorrect) to the artificial neural network 100 via input nodes 110 a-n or may transmit such information to one or more nodes. The feedback system 150 may additionally or alternatively be coupled to the storage 170 such that output is stored. The feedback system may not have correct answers at all, but instead base feedback on further processing: for example, the feedback system may comprise a system programmed to identify faces, such that the feedback allows the artificial neural network 100 to compare its results to that of a manually programmed system.

The artificial neural network 100 may be dynamically modified to learn and provide better input. Based on, for example, previous input and output and feedback from the feedback system 150, the artificial neural network 100 may modify itself. For example, processing in nodes may change and/or connections may be weighted differently. Following on the example provided previously, the facial prediction may have been incorrect because the photos provided to the algorithm were tinted in a manner which made all faces look red. As such, the node which excluded sections of photos containing large contiguous sections of the color red could be considered unreliable, and the connections to that node may be weighted significantly less. Additionally or alternatively, the node may be reconfigured to process photos differently. The modifications may be predictions and/or guesses by the artificial neural network 100, such that the artificial neural network 100 may vary its nodes and connections to test hypotheses.

The artificial neural network 100 need not have a set number of processing nodes or number of sets of processing nodes, but may increase or decrease its complexity. For example, the artificial neural network 100 may determine that one or more processing nodes are unnecessary or should be repurposed, and either discard or reconfigure the processing nodes on that basis. As another example, the artificial neural network 100 may determine that further processing of all or part of the input is required and add additional processing nodes and/or sets of processing nodes on that basis.

The feedback provided by the feedback system 150 may be mere reinforcement (e.g., providing an indication that output is correct or incorrect, awarding the machine learning algorithm a number of points, or the like) or may be specific (e.g., providing the correct output). For example, the machine learning algorithm 100 may be asked to detect faces in photographs. Based on an output, the feedback system 150 may indicate a score (e.g., 75% accuracy, an indication that the guess was accurate, or the like) or a specific response (e.g., specifically identifying where the face was located).

The artificial neural network 100 may be supported or replaced by other forms of machine learning. For example, one or more of the nodes of artificial neural network 100 may implement a decision tree, associational rule set, logic programming, regression model, cluster analysis mechanisms, Bayesian network, propositional formulae, generative models, and/or other algorithms or forms of decision-making. The artificial neural network 100 may effectuate deep learning.

A large language model may be a language model characterized by its large size. Their size is enabled by AI accelerators, which are able to process vast amounts of text data, mostly scraped from the Internet. The artificial neural networks which are built can contain from tens of millions and up to billions of weights and are (pre-) trained using self-supervised learning and semi-supervised learning. Transformer architecture contributed to faster training.

As language models, they work by taking an input text and repeatedly predicting the next token or word. Up to 2020, fine tuning was the only way a model could be adapted to be able to accomplish specific tasks. Larger sized models, such as GPT-3, however, can be prompt-engineered to achieve similar results. They are thought to acquire embodied knowledge about syntax, semantics and “ontology” inherent in human language corpora large language models are trained using self-supervised learning or semi-supervised learning. This means that they are trained on large amounts of unlabeled text. Large language models can adjust their internal parameters and learn from new inputs from users over time.

Large language models are trained to predict the next word in a sentence based on the previous input sentence. This is a self-supervised learning task because you are not defining separate output labels. The process is repeated until the model reaches an acceptable level of accuracy. Some large language models, like InstructGPT and ChatGPT, use both supervised learning and reinforcement learning. The combination of the two is crucial for optimal performance.

### CNN

The features from photographs or images may be extracted in a variety of ways. In one embodiment, the features are extracted using computer vision techniques and a variety of computer vision techniques are possible. In other embodiments, features are extracted using pre-trained machine learning models. For example, the pre-trained machine learning model may be a convolutional neural network (CNN). The CNN may be trained on millions of images of people and may have learned to understand the thoughts from the photos. This CNN may be novel because it has been created and trained on known images only. Logically, other types of learning algorithms in the estimator may be used. For example, the learning algorithm may be a fully connected neural network (FCN) in one embodiment.

Turning the images into data may entail taking measurements of different points on the object. The points may be compared to baseline of measurements for the object and the changes may be noted. The system may then analyze the changes to determine the extent of movement.

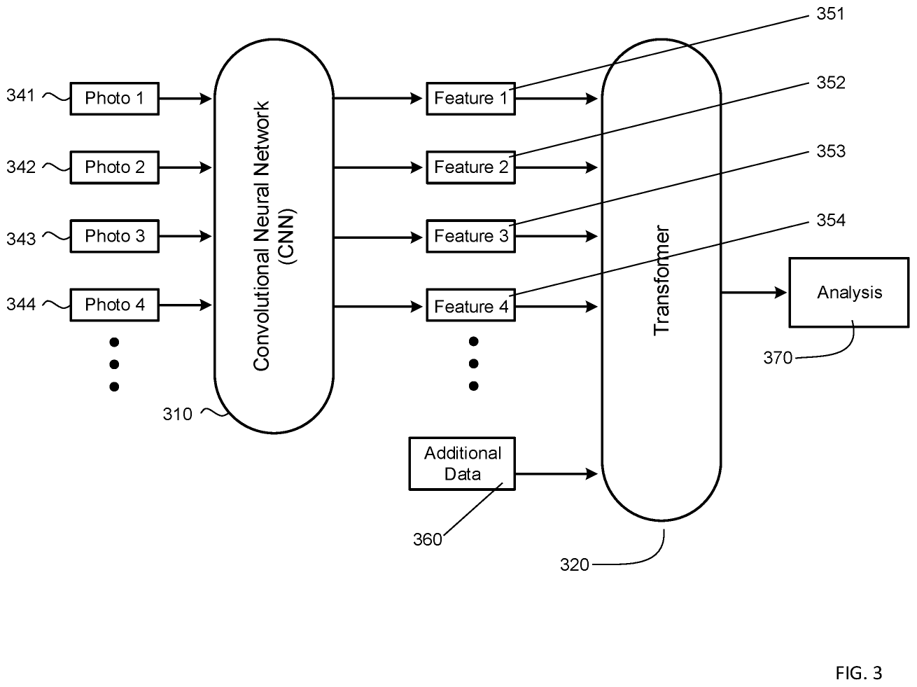

More specifically, referring to FIG. 3, the learning algorithm may include a convolutional neural network 310 (CNN) and a transformer 320. In one embodiment, the CNN 310 may determine one or more features 351-354 in each photo 341-344. In one example, the CNN may determine the features 351-354 which may be a set of numbers but the amount of features 351-354 may be varied up or down depending on many factors.

The CNN may be trained on millions of images of people or objects or document scans This CNN may be novel because it has been created and trained on known images. Logically, other types of learning algorithms in the may be used. For example, the learning algorithm may be a fully connected neural network (FCN) in one embodiment. The analysis of the features may indicate the changes to the physical appearance.

In training, the transformer 320 may take the features 351-354 of multiple images 341-344 of the same person or thing (the outputs of the CNN) as well as additional data such as the stated damage of the vehicle in the photo 360 to create a model. Once the model is trained, the transformer may generate an analysis which may be a prediction of the damage to the vehicle 370. In some embodiments, the analysis which may be estimation of the damage 370 may be in real time. The transformer 320 used in this invention may be trained on a dataset specifically created for predicting damage 370.

The trained model which may be in the transformer 320 may take the features of multiple images 341-344 of the same object as well as outside information in order to predict the damage to the vehicle, for example. The learning algorithm also may analyze other relevant information about the object.

As mentioned, the machine learning algorithm may analyze features to determine a weight for each feature as related to insurance fraud. The weights may be applied to features in new insurance claims to determine a trust total. For example, a first feature may be weighted more heavily than a second feature as the first feature may have a large impact on determining whether a claim is legitimate or needs to be further reviewed for fraud. In some embodiments, humans may intervene and adjust the weights as desired.

The trust total may be compared to a threshold to determine insurance claims that are likely fraudulent. Referring again to FIG. 2, at block 210, the system and method may determine if the trust score is over a threshold. In one embodiment, the weights may be applied to features to determine feature totals and feature totals may be compared to feature thresholds to determine insurance claims that are likely fraudulent. In other words, each feature may be viewed independently and any feature over a feature specific feature threshold may be a cause for a claim to be determined to be fraudulent. Logically, there may be a variety of ways to review the feature totals in view of the threshold such as determining whether two of the feature totals are over their individual feature thresholds or whether the total of the feature totals is over a threshold.

Similar to the determining features, the trust total threshold may be set by a machine learning algorithm that analyzes past incidents of insurance fraud. The machine learning algorithm may determine a low threshold may have too many false positives while a threshold that is too high may let fraudsters get away with fraud. Further, the trust total threshold may be refined over time as the actions of fraudsters adjust to the improved level of review. The machine learning created threshold may be different for each insurance company and for each type of insurance.

At block 215, in response to the trust total score being over the threshold, the system and method may proceed to pay out the claim. If the trust total score is over the threshold, the system and method may have concluded that the insurance claim is likely not fraudulent.

At block 220, in response to the trust score being under the threshold, additional action may be taken to investigate whether the claim is fraudulent. In a simple embodiment, the insurance company may simply flag the claim for further investigation which may entail requiring an in-person validation of the claimed damage, more closely reviewing any police reports, interviewing any witnesses, etc. In another embodiment, a configurable rules engine may provide configurable rules on future steps. The rules may be specific to each insurance company and each insurance type.

As mentioned, the configurable rules engine may be specific to each insurance company. For example, some insurance companies may elect to validate the claimed damage through additional photos, or for one of their staff to validate the damage, or an in-network collision repair facility. Logically, the configurable rules may be distinct for each of the described insurance companies.

The rules engine may also be guided by a machine learning analysis of past claims which may create a list of steps to take to bring a claim to a conclusion. The machine learning algorithm may identify features that may be used to determine the next recommended step or steps in handling a claims. For example, some claims may be under the trust threshold and the machine learning algorithm may indicate interviewing witnesses may bring the claim to a conclusion. In other examples, the machine learning algorithm may indicate interviewing witnesses, viewing the damage in person and reviewing crash data from the vehicles in an accident may be recommended. In a more detailed example, crash photos may indicate minor damage to a vehicle where the estimated repairs are so great that they do not match the damage in the photos. The learning algorithm may flag the discrepancy and recommend a trusted agent view the damage in person, examine the crash scene and/or speak to the police officer who wrote the crash report.

Logically, the configurable rules engine may vary by type of insurance and by the insurance company and the rules engine may change and improve over time. For example, as more fake photos of damage are submitted, more in person reviews of damage may become necessary. Finally, humans at the insurance carrier may modify the recommendations. For example, some companies may adopt proprietary secure technology that may allow a user to broadcast a video of the damage to an insurance representative in a secure and trusted way which may reduce the chance of fake images being submitted.

The system and method may address and solve many important technical problems in current insurance claim processing. Initially, the data related to insurance claims is often haphazard and varies by claim types and reporting mechanism. For example, some claims may have a plurality of notes which may relate to different aspects of the claim. The system and method may use machine learning to properly classify or normalize the data into a standard format for further consistent and efficient review.

In addition, dealing with fraudsters is an evolving problem which requires speed and intelligence in order to keep up with the always changing and improving approaches of the fraudsters. With so many claims, it is impossible for a person or a team of people to keep up with the approaches of the fraudsters. By the time a new method of fraud is determined, millions or billions of dollars may be lost. Using machine learning and large computer systems, the universe of claims may be analyzed by a single system and method which may recognize fraud patterns and fraud approaches well before any human or teams of humans.

In some systems and methods, the data on claims is shared across insurance companies in an anonymized way to assist in identifying world-wide patterns of fraud. Again, the volume of data would be impossible for a person or team of person to analyze and the analysis will be improved.

In addition, the physical systems may be modified to speed the analysis, processing and further analysis of the claims. Specific data structures may be designed to hold the normalized data. Similarly, specific APIs may be created to submit data to the analysis system which may aid in the efficient and accurate ingestion of data. Processors may be physically designed to efficient handle the large amount of data and to aid in the machine learning aspects of the system. For example, machine learning techniques may require large amounts of fast memory and the system may be adapted to provide such memory. Similarly, mobile devices may be used to submit a large number of claims and the system may be adapted to efficiently receive data from mobile devices in an efficient manner.

The system may be provided to insurers or may be available as a service to insurers. For example, the system may be installed physically at an insurance provider or the insurance provider may communicate data to the system which may be remote or in a cloud and the remote system may provide the necessary instructions on how to handle the claims.

### Computing Devices

Computing devices are used through the method and system. Logically, the computing devices may be designed to facilitate the specific tasks that may be part of the method. For example, the large language model may use processors that have superior graphic capabilities to make the large language model operate more efficiently.

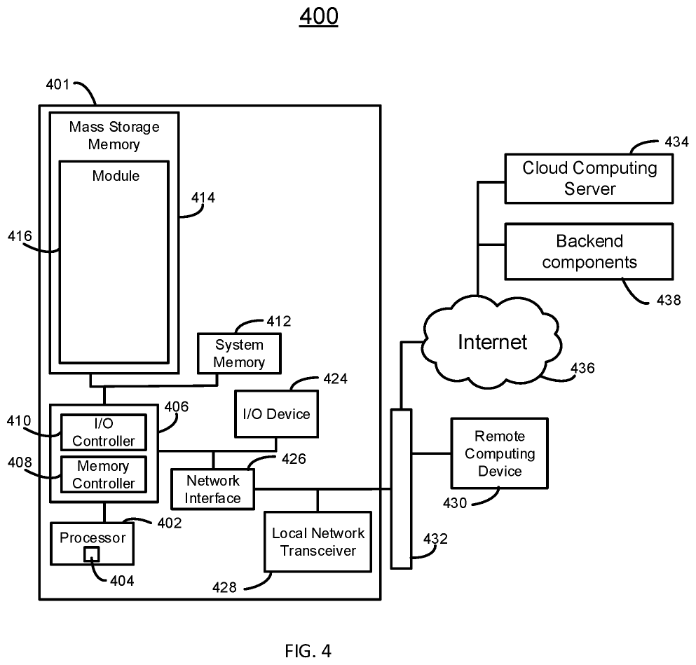

As shown in FIG. 4, the computing device 401 that executes the method may include a processor 402 that is coupled to an interconnection bus. The processor 402 may include a register set or register space 404, which is depicted in FIG. 4 as being entirely on-chip, but which could alternatively be located entirely or partially off-chip and directly coupled to the processor 402 via dedicated electrical connections and/or via the interconnection bus. The processor 402 may be any suitable processor, processing unit or microprocessor. Although not shown in FIG. 4, the computing device 401 may be a multi-processor device and, thus, may include one or more additional processors that are identical or similar to the processor 402 and that are communicatively coupled to the interconnection bus.

The processor 402 of FIG. 4 may be coupled to a chipset 406, which includes a memory controller 408 and a peripheral input/output (I/O) controller 410. As is well known, a chipset may typically provide I/O and memory management functions as well as a plurality of general purpose and/or special purpose registers, timers, etc. that are accessible or used by one or more processors coupled to the chipset 406. The memory controller 408 may perform functions that enable the processor 402 (or processors if there are multiple processors) to access a system memory 412 and a mass storage memory 414, that may include either or both of an in-memory cache (e.g., a cache within the memory 412) or an on-disk cache (e.g., a cache within the mass storage memory 414).

The system memory 412 may include any desired type of volatile and/or non-volatile memory such as, for example, static random access memory (SRAM), dynamic random access memory (DRAM), flash memory, read-only memory (ROM), etc. The mass storage memory 414 may include any desired type of mass storage device. For example, the computing device 401 may be used to implement a module 416 (e.g., the various modules as herein described). The mass storage memory 414 may include a hard disk drive, an optical drive, a tape storage device, a solid-state memory (e.g., a flash memory, a RAM memory, etc.), a magnetic memory (e.g., a hard drive), or any other memory suitable for mass storage. As used herein, the terms module, block, function, operation, procedure, routine, step, and method refer to tangible computer program logic or tangible computer executable instructions that provide the specified functionality to the computing device 401, the systems and methods described herein. Thus, a module, block, function, operation, procedure, routine, step, and method can be implemented in hardware, firmware, and/or software.

In one embodiment, program modules and routines may be stored in mass storage memory 414, loaded into system memory 412, and executed by a processor 402 or may be provided from computer program products that are stored in tangible computer-readable storage mediums (e.g. RAM, hard disk, optical/magnetic media, etc.).

The peripheral I/O controller 410 may perform functions that enable the processor 402 to communicate with a peripheral input/output (I/O) device 424, a network interface 426, a local network transceiver 428, (via the network interface 426) via a peripheral I/O bus. The I/O device 424 may be any desired type of I/O device such as, for example, a keyboard, a display (e.g., a liquid crystal display (LCD), a cathode ray tube (CRT) display, etc.), a navigation device (e.g., a mouse, a trackball, a capacitive touch pad, a joystick, etc.), etc. The I/O device 424 may be used with the module 416, etc., to receive data from the transceiver 428, send the data to the components of the system 100, and perform any operations related to the methods as described herein. The local network transceiver 428 may include support for a Wi-Fi network, Bluetooth, Infrared, cellular, or other wireless data transmission protocols. In other embodiments, one element may simultaneously support each of the various wireless protocols employed by the computing device 401. For example, a software-defined radio may be able to support multiple protocols via downloadable instructions. In operation, the computing device 401 may be able to periodically poll for visible wireless network transmitters (both cellular and local network) on a periodic basis. Such polling may be possible even while normal wireless traffic is being supported on the computing device 401. The network interface 426 may be, for example, an Ethernet device, an asynchronous transfer mode (ATM) device, an 802.11 wireless interface device, a DSL modem, a cable modem, a cellular modem, etc., that enables the system 100 to communicate with another computer system having at least the elements described in relation to the system 100.

While the memory controller 408 and the I/O controller 410 are depicted in FIG. 4 as separate functional blocks within the chipset 406, the functions performed by these blocks may be integrated within a single integrated circuit or may be implemented using two or more separate integrated circuits. The computing environment 400 may also implement the module 416 on a remote computing device 430. The remote computing device 430 may communicate with the computing device 401 over an Ethernet link 432. In some embodiments, the module 416 may be retrieved by the computing device 401 from a cloud computing server 434 via the Internet 436. When using the cloud computing server 434, the retrieved module 416 may be programmatically linked with the computing device 401. The module 416 may be a collection of various software playgrounds including artificial intelligence software and document creation software or may also be a Java® applet executing within a Java® Virtual Machine (JVM) environment resident in the computing device 401 or the remote computing device 430. The module 416 may also be a “plug-in” adapted to execute in a web-browser located on the computing devices 401 and 430. In some embodiments, the module 416 may communicate with back end components 438 via the Internet 436.

The system 400 may include but is not limited to any combination of a LAN, a MAN, a WAN, a mobile, a wired or wireless network, a private network, or a virtual private network. Moreover, while only one remote computing device 430 is illustrated in FIG. 6 to simplify and clarify the description, it is understood that any number of client computers may be supported and may be in communication within the system 400.

Additionally, certain embodiments may be described herein as including logic or a number of components, modules, blocks, or mechanisms. Modules and method blocks may constitute either software modules (e.g., code or instructions embodied on a machine-readable medium or in a transmission signal, wherein the code is executed by a processor) or hardware modules. A hardware module may be a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” may be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” may refer to a hardware module. Considering embodiments in which hardware modules are temporarily configured (e.g., programmed), each of the hardware modules need not be configured or instantiated at any one instance in time. For example, where the hardware modules include a processor configured using software, the processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification may be presented in terms of algorithms or symbolic representations of operations on data stored as bits or binary digital signals within a machine memory (e.g., a computer memory). These algorithms or symbolic representations may be examples of techniques used by those of ordinary skill in the data processing arts to convey the substance of their work to others skilled in the art. As used herein, an “algorithm” may be a self-consistent sequence of operations or similar processing leading to a desired result. In this context, algorithms and operations may involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, may be merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “embodiments,” “some embodiments” or “an embodiment” or “teaching” may mean that a particular element, feature, structure, or characteristic described in connection with the embodiment is included in at least one embodiment. The appearances of the phrase “in some embodiments” or “teachings” in various places in the specification may not necessarily all be referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments may not be limited in this context.

Further, the figures depict preferred embodiments for purposes of illustration only. One skilled in the art may be readily recognize from the following discussion that alternative embodiments of the structures and methods illustrated herein may be employed without departing from the principles described herein.

Upon reading this disclosure, those of skill in the art may appreciate still additional alternative structural and functional designs for the systems and methods described herein through the disclosed principles herein. Thus, while particular embodiments and applications have been illustrated and described, it is to be understood that the disclosed embodiments may not be limited to the precise construction and components disclosed herein. Various modifications, changes and variations, which may be apparent to those skilled in the art, may be made in the arrangement, operation and details of the systems and methods disclosed herein without departing from the spirit and scope defined in any appended claims.

1. A method of determining fraud in an insurance claim analysis:
determining whether a user desires a cash payout;
in response to determining the user desires a cash payout:
determining a trust score for the user using a trust engine;
determining if the trust score is over a threshold;
in response to the trust score being over the threshold, proceeding to pay out the claim;
in response to the trust score being under the threshold, proceeding to follow a configurable rules engine on future steps to evaluate the claim for fraud.

2. The method of claim 1, wherein data on insurance claims is normalized.

3. The method of claim 1, wherein the configurable rules engine is configured according to insurance company specific rules.

4. The method of claim 1, wherein the configurable rules are set by a machine learning algorithm.

5. The method of claim 4, wherein the configurable rules set by a machine learning algorithm are adjusted by insurance company users.

6. The method of claim 2, wherein determining a trust score further comprises:
determining if the user has recently made a change to their insurance or just opened a new policy;
in response to determining that the user has recently made a change to their insurance or opened a new policy, decreasing the trust score.

7. The method of claim 2, wherein determining a trust score further comprises:
determining if the user is on a list of known fraudulent users;
in response to determining if the user is on the list of known fraudulent users, decreasing the trust score.

8. The method of claim 2, wherein determining a trust score further comprises:
determining if the user has a relevant history of no claims;
in response to determining that the user has a relevant history of no claims, increasing the trust score.

9. The method of claim 2, wherein determining a trust score further comprises:
determining if the user has any past claims where a cash payout request was not requested;
in response to determining that the user does not have any past claims where a cash payout request was not requested, increasing the trust score.

10. The method of claim 2, wherein determining a trust score further comprises:
determining a location of an incident;
comparing the location to fraud incident locations in the past;
adjusting the trust score down if the location is similar to a location of a fraud incident in the past.

11. The method of claim 2, further comprising gathering data from additional sources related to trust and adjusting the trust score based on the data from additional sources.

12. The method of claim 2, further comprising determining if an additional party to the incident has a negative trust rating and in response to determining the additional party has a negative trust rating, adjust the trust score down.

13. The method of claim 2, wherein past instances of insurance fraud are analyzed by a machine learning algorithm to determine features that are related to insurance fraud.

14. The method of claim 13, wherein features are analyzed to determine a weight for each feature as related to insurance fraud.

15. The method of claim 14, wherein the weights are applied to features in new insurance claims to determine a trust total and the trust total is compared to a threshold to determine insurance claims that are likely fraudulent.

16. The method of claim 15, wherein the trust total threshold is set by studying past incidents of insurance fraud.

17. The method of claim 15, wherein the weights are applied to features to determine feature totals and feature totals are compared to feature thresholds to determine insurance claims that are likely fraudulent.

18. The method of claim 15, wherein insurance claims that are likely fraudulent are subject to additional review.

19. The method of claim 2, wherein the trust engine is configured according to trust rules specific to each insurance company.

20. The method of claim 19, wherein the trust rules are modified by users.
